(19) United States
(12) Patent Application Publication
(10) Pub. No.: US 2013/0112039 A1
(43) Pub. Date: May 9, 2013

(54) VIBRATION-DAMPED PRECISION CAST ALUMINUM ALLOY AUTOMOTIVE MEMBER FOR A VEHICLE POWERTRAIN AND METHOD OF MANUFACTURING THE SAME

(71) Applicants: Michael D. Hanna, West Bloomfield, MI (US); Andrew Sansome, Ivanhoe (AU)

(72) Inventors: Michael D. Hanna, West Bloomfield, MI (US); Andrew Sansome, Ivanhoe (AU)

(73) Assignee: GM GLOBAL TECHNOLOGY OPERATIONS LLC, Detroit, MI (US)

(21) Appl. No.: 13/292,474

(22) Filed: Nov. 9, 2011

(51) Int. Cl. F16H 57/032; B22D 25/02; F16H 57/028; B22D 19/00

(52) U.S. Cl. 74/606 R; 164/98; 164/75

(57) ABSTRACT

A vibration-damped precision cast aluminum alloy automotive member for a vehicle powertrain and a method of its manufacture are disclosed. The vibration-damped precision cast aluminum alloy automotive member includes an internally disposed aluminum or aluminum alloy insert. An exterior surface of the insert, which includes an exposed oxide film, establishes a non-bonded interface with an interior surface of the automotive powertrain member. This non-bonded interface damps vibration propagation through the automotive powertrain member by experiencing frictional contacting movement when the automotive powertrain member is vibrationally excited.

### TECHNICAL FIELD

The technical field of this disclosure relates generally to a vibration-damped precision cast aluminum alloy automotive member for use in a vehicle powertrain. The vibration-damped automotive member includes an internally disposed insert constructed from aluminum or an aluminum alloy. An exterior surface of the insert includes an exposed oxide film and forms a non-bonded interface with an interior surface of the automotive member. A method for making the vibration-damped precision cast aluminum alloy automotive powertrain member is also disclosed.

### BACKGROUND

The chassis of a vehicle includes a structural frame and a powertrain supported by the frame. The powertrain includes a variety of mechanical and/or electrochemical components that generate and transfer power to enable an operator to drive the vehicle. Some of the mechanical and/or electrochemical components that may be included in the powertrain include, for example, an internal combustion engine, a fuel cell, a lithium-ion battery, a transmission, a differential, and, additionally, in the case of a hybrid-electric vehicle, an invertor and an electric motor. Many of these components include precision cast automotive members, such as housings or covers, that are now being manufactured from an aluminum alloy instead of a heavier steel alloy to promote vehicle weight reduction and fuel efficiency.

The normal operation of a vehicle employs many different mechanical motions and interactions within the vehicle chassis to provide driving and steering capabilities. Clutches and gears are routinely engaged and disengaged, the reciprocating motion of pistons within engine block cylinders is accelerated and decelerated, and crankshafts, camshafts, and axles are rotated at varying speeds, to name but a few of the mechanical motions and interactions that regularly transpire during vehicle use. Each of these mechanical events may cause or exacerbate the reverberation of vibrations through the vehicle chassis. These vibrations can sometimes be felt and, if they fall within a particular frequency, heard by the operator of the vehicle as well as any other commuters that may be present in the passenger compartment. Moreover, aluminum alloys tend to experience more pronounced vibration propagation than steel alloys when subjected to vibrational excitement.

Similar vibration and noise concerns have been identified in other locations of a vehicle—most notably the braking system. One approach that has been developed to alleviate the effects of braking-induced vibrations is to place a metallic insert within a cast iron brake rotor where intense frictional interactions are experienced with selectively actuated brake pads. The metallic insert is disposed within a rotor cheek portion of the brake rotor and forms a non-bonded internal interface with the rotor cheek over an appreciable surface area. A coating that includes small refractory particles dispersed within a heat-resistant binder material is usually applied quite liberally to an exterior surface of the insert to prevent the insert and the rotor cheek from forming an integral metallurgical bond during manufacture (i.e., casting) or operation of the brake rotor. The metallic insert is generally constructed from a high-temperature resistant material, such as steel, so that it withstand the constant frictional stress applied by the nearby brake pads and the relatively high surface temperatures often generated.

Precision cast aluminum alloy automotive members included in the powertrain of a vehicle and its supporting frame, however, are not subjected to the type of selective frictional stress and rapid heat generation routinely encountered by a brake rotor. Because of this variation in operating environments, different manufacturing and material options are potentially available for vibration-damping precision cast aluminum alloy automotive members as compared to the vibration damping work associated with a brake rotor. The ability to vibration-damp precision cast aluminum alloy automotive members in a simple, practical, and effective manner without implementing burdensome and time-consuming manufacturing practices would help eliminate various engineering and economical barriers that may prevent their widespread use.

### SUMMARY OF THE DISCLOSURE

A vibration-damped precision cast aluminum alloy automotive member for a vehicle powertrain includes an internally disposed aluminum or aluminum alloy insert. An oxide film is present at an exterior surface of the insert and, preferably, entirely around the insert so that no bare aluminum or aluminum alloy surface is exposed. The oxide film establishes a non-bonded interface with an interior surface of the precision cast automotive powertrain member. Frictional contacting movement is able to transpire at this interface when vibrations are imparted to the automotive member during normal operation of the powertrain. Such frictional interactions convert mechanical vibratory energy into dissipating thermal energy. This, in turn, weakens vibration resonance through the automotive powertrain member and helps alleviate the actual and/or perceived discomfort associated with vibrations and noise that may emanate from the chassis during vehicle operation. A non-exhaustive listing of precision cast aluminum alloy automotive powertrain members that may include the internally disposed aluminum or aluminum alloy insert are a transmission housing, an electric motor housing, a differential housing, an invertor housing, and a support bracket, to name but a few.

The oxide film may be formed at the exterior surface of the aluminum or aluminum alloy insert by natural self-passivation and/or anodizing. Natural self-passivation occurs when a bare aluminum or aluminum alloy surface is exposed to oxygen causing the almost instantaneous formation of a thin, amorphous oxide film. Anodizing is an electrochemical process in which an oxide film can be grown on a bare or passivated aluminum or aluminum alloy surface to much greater thicknesses than is typically derived through natural self-passivation. The oxide film at the exterior surface of the insert can exhibit a variety of physical and chemical properties and is preferably about 1 nm to about 20 μm thick. An intended function of the oxide film is to facilitate the formation of the non-bonded interface between the exterior surface of the insert and the adjacent interior surface of the automotive powertrain member during precision casting of the automotive powertrain member around the insert. Such a functional attribute of the oxide film obviates the need to coat the insert with conventional coatings that include small refractory particles bound within a heat resistant binder material.

The precision casting process employed to manufacture the vibration-damped aluminum alloy automotive powertrain member can be any process that uses a re-useable die and which can repeatedly make complex aluminum alloy parts within tight dimensional tolerances. Several exemplary types of suitable precision casting processes include cold chamber die casting, squeeze casting, and gravity casting. These and other precision die casting processes involve solidifying a molten aluminum alloy charge around the aluminum or aluminum alloy insert in a die cavity configured to resemble the particular automotive powertrain member being cast. The oxide film at the exterior surface of the insert protectively shields the insert from the molten aluminum alloy charge and prevents wetting at the exterior surface so that metallurgical bonding does not occur with the adjacent interior surface of the automotive powertrain member.

The preferred process for making the vibration-damped aluminum alloy automotive powertrain member is cold chamber die casting. This process involves first locating the aluminum or aluminum alloy insert, which includes an exposed oxide film at an exterior surface, in a die cavity of a re-useable die defined by a cover die half and an ejector die half. The thickness, porosity, solid state microstructure, and other physical and chemical properties of the oxide film can be tailored to their desired specifications. After the re-useable die is closed, a molten aluminum alloy charge is introduced into the die cavity at an elevated pressure into contact with, and around, the insert. The molten aluminum alloy charge is then solidified around the insert in the die cavity to form the vibration-damped automotive powertrain member. The subsequent opening of the re-useable die permits removal of the vibration-damped precision cast automotive powertrain member so that any additional cooling and or machining can be performed. This process can be repeated rather quickly—on the order of minutes per cycle—to reliably and accurately manufacture the vibration-damped automotive powertrain member in large quantities, if needed, without significant scheduled downtime between cycles.

### BRIEF DESCRIPTION OF THE DRAWINGS

FIG. 1 illustrates one exemplary embodiment of a vibration-damped precision cast aluminum alloy automotive member for use in a vehicle powertrain. More specifically, the automotive powertrain member illustrated in FIG. 1 is a generalized transmission housing shown from the side. The vibration-damped precision cast aluminum alloy transmission housing includes an internally disposed aluminum or aluminum alloy insert.

FIG. 2 is a partial cross-sectional view of the vibration-damped precision cast aluminum alloy transmission housing shown in FIG. 1 along a longitudinal axis of the transmission housing.

FIG. 3 illustrates another exemplary embodiment of a vibration-damped precision cast aluminum alloy automotive member for use in a vehicle powertrain. In this Figure, the automotive powertrain member is an electric motor housing shown in perspective view. The vibration-damped precision cast aluminum alloy electric motor housing includes an internally disposed aluminum or aluminum alloy insert.

FIG. 4 illustrates yet another exemplary embodiment of a vibration-damped precision cast aluminum alloy automotive member for use in a vehicle powertrain. Here, the automotive powertrain member is a differential housing shown in perspective view. The vibration-damped precision cast aluminum alloy differential housing includes an internally disposed aluminum or aluminum alloy insert.

FIGS. 5-9 schematically illustrate an exemplary precision casting process suitable for making any of the vibration-damped automotive powertrain members shown in FIGS. 1-4 as well as automotive powertrain members not specifically shown and described.

### DETAILED DESCRIPTION OF PREFERRED EMBODIMENTS

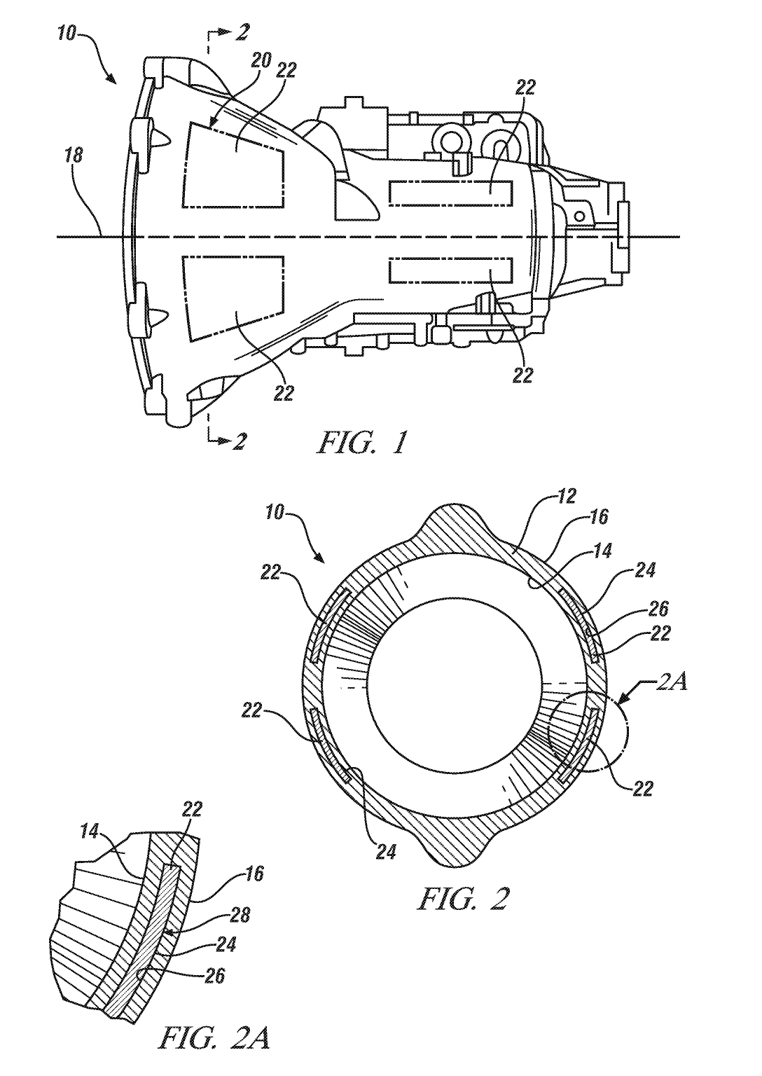

Several embodiments of a vibration-damped precision cast aluminum alloy automotive member for a vehicle powertrain are shown in FIGS. 1-4. Each of these disclosed automotive powertrain members includes an internally disposed aluminum or aluminum alloy insert. The insert includes an exterior surface which forms a non-bonded interface with an interior surface of the precision cast aluminum alloy automotive powertrain member. Frictional contacting movement is able to transpire at this interface when vibrations are imparted to the automotive member during normal operation of the powertrain. Such frictional interactions convert mechanical vibratory energy into dissipating thermal energy. This, in turn, weakens vibration resonance through the automotive powertrain member and limits the ability of any surviving vibrations to sustain a disruptive, audible noise. To prevent wetting of the insert during precision casting of the automotive powertrain part and, consequently, to establish the non-bonded interface, an oxide film is present at the exterior surface of the insert.

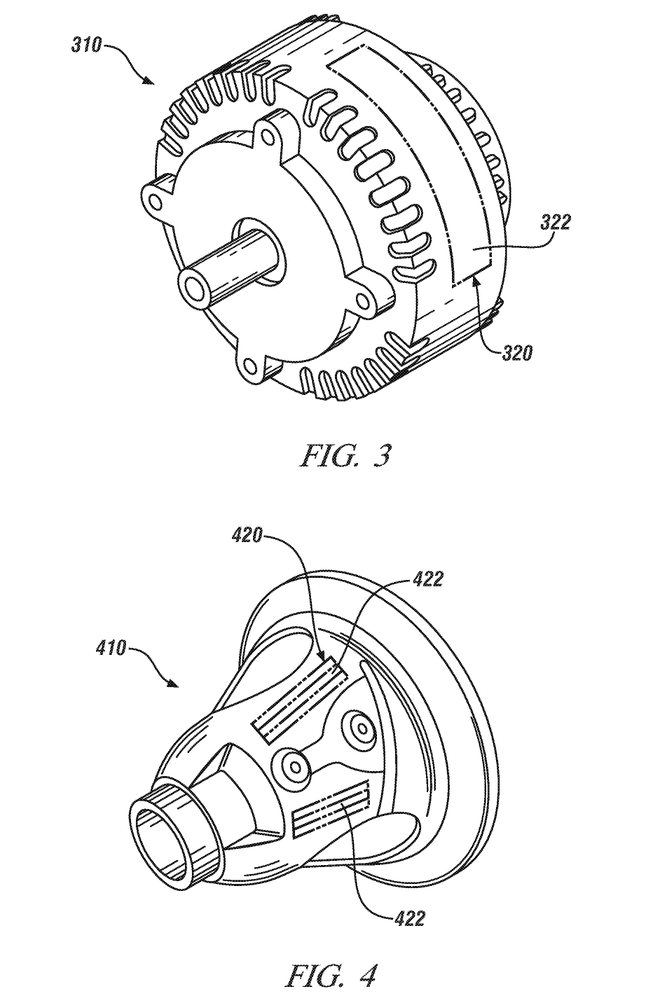

FIGS. 1 and 2 generally illustrate a vibration-damped transmission housing 10 that is precision cast from an aluminum alloy. The vibration-damped transmission housing 10 is the enclosure structure of a transmission (not shown) and encloses, among others, a portion of an input shaft, a portion of an output shaft, and a gear train. The transmission is part of a powertrain which is supported by a structural frame. The overall function of the transmission is to transfer speed and torque, either manually or automatically, from the power-generating components of the powertrain (engine, battery, and/or fuel cell, etc.) to the drive wheels at a desired gear ratio consistent with a selected gear position (forward, neutral, reverse). The vibration-damped transmission housing 10 protects the gear train and other enclosed mechanical transmission elements from debris and, if applicable, provides containment for a lubricating transmission fluid. Any suitable aluminum alloy may be employed to make the transmission housing 10 including, for example, AA319, AA356, AA360, AA380, AA383, AA834, AA390, and AA413.

The vibration-damped transmission housing 10 comprises a structural wall 12 that includes an inner surface 14 and an outer surface 16 when viewed in cross-section along a longitudinal axis 18. The inner surface 14 supports a variety of integrally formed or non-intergrally located features that accommodate inclusion of the gear train within the transmission housing 10. The outer surface 16 is less complex than the inner surface 14 and may include attachment features or other surface modifications that help secure the transmission housing 10 in place within the powertrian. The thickness of the structural wall 12 between the inner and outer surfaces 14, 16 is relatively thin and may vary around the housing 10. A typical thickness of the structural wall 12 usually ranges from about 2 mm to about 20 mm, more preferably from about 3 mm to about 12 mm, and most preferably from about 4 mm to about 8 mm. Skilled artisans will know and appreciate that many different shapes and configurations of the transmission housing 10 are possible depending on the type and design of the transmission that is meant to be housed as well as other design constraints that may be applicable.

Disposed within the structural wall 12 between the inner surface 14 and the outer surface 16 at a selected damping region 20 is an aluminum or aluminum alloy insert 22. The selected damping region 20 may be any predefined section of the structural wall 12 in which the relevant experience of a skilled artisan, empirical data, computer simulation, and/or experimental data suggests that vibrations are likely to originate or propagate. Large, relatively consistently-shaped areas of the structural wall 12 without highly intricate and complex geometric contours are the most preferred locations for the damping region 20. These areas provide the aluminum or aluminum alloy insert 22 and the structural wall 12 with a sufficient surface area at which frictional contacting movement can occur while avoiding structural interference as much as possible. More than one aluminum or aluminum alloy insert 20 may be disposed within the structural wall 12 of the transmission housing 10, if desired, as shown in FIGS. 1 and 2. Any type of aluminum alloy may be used to make the insert 22 including those specific types, mentioned earlier, that are normally employed to precision cast the transmission housing 10.

An exterior surface 24 of the aluminum or aluminum alloy insert 22 and an interior surface 26 of the transmission housing 10 form a non-bonded interface 28 supportive of frictional contacting movement when the transmission housing 10 is vibrationally excited during, for example, the constant engagement and disengagement of the individual meshed gears within the gear train and other various mechanical interactions (i.e., those encountered by the flywheel, clutch plates, etc.). This non-bonded interface 28 facilitates rubbing engagement between physically distinct surfaces which are not metallurgically or otherwise immovably bonded together. And as already mentioned, such relative interfacial frictional movement converts mechanical vibratory energy into thermal energy which, in turn, disrupts vibration propagation and helps lessen any associated noise dissemination from the transmission housing 10. The non-bonded interface 28 formed between the exterior surface 24 of the aluminum or aluminum alloy insert 22 and the interior surface 26 of the transmission housing 10 is established during precision casting of the housing 10, as further described below, and is preferably present around the entirety of the insert 22.

The exterior surface 24 of the aluminum or aluminum alloy insert 22 includes an exposed oxide film that facilitates formation of the non-bonded interface 28. The oxide film is preferably composed primarily of aluminum oxide (Al₂O₃) and may vary in thickness, overall composition, and solid state microstructure depending on the how the film is prepared. A preferred thickness of the oxide film at the exterior surface 24 of the insert 22 ranges anywhere from about 1 nm to about 20 μm. An amorphous oxide film of about 1 nm to about 15 nm, for example, can be formed naturally on a bare aluminum or aluminum alloy surface by exposing that surface to oxygen, usually in air, at a temperature that promotes self-passivation. A temperature that is favorable to the formation of the natural self-passivated amorphous oxide film is room temperature of about 18° C. to about 23° C. A thicker oxide film up to 20 μm, however, can be formed by anodizing a passivated (i.e., one that includes the natural oxide film) or a bare aluminum or aluminum alloy surface. Anodizing techniques, in addition to permitting the formation of thicker oxide films, can also affect the porosity of the oxide film and influence whether the oxide film is amorphous or crystalline, among other physical and chemical properties that may be varied.

The presence of the oxide film at the exterior surface 24 of the aluminum or aluminum alloy insert 22 protectively shields the insert 22 from molten aluminum alloy during precision casting of the transmission housing 10. The molten aluminum alloy fully or partially surrounds the insert 22 during precision casting, as further explained below, but does not wet the insert 22 and, consequently, does not form an integral metallurgical bond with the exterior surface 24 of the insert 22 during solidification. Because of the protective functionality of the oxide film, there is no need to apply conventional coatings to the aluminum or aluminum alloy insert 22 in order to establish the non-bonded interface 28; that is, the exterior surface 24 of the aluminum or aluminum alloy insert 22 does not have to be covered with small refractory particles—such as graphite, alumina, and/or silica—bound within a heat resistant binder material commonly composed of an epoxy resin, a vinyl ester resin, a lignosulfonate binder, a calcium aluminate cement, or a wood flour cement. The non-necessity of such conventional refractory particle based coatings simplifies the manufacture of the vibration-damped transmission housing 10 and other automotive powertrain members, lowers associated costs, improves vibration damping consistency and reliability, and reduces unit weight and overall material usage, to name but a few beneficial effects.

The aluminum or aluminum alloy insert 22 is preferably sized and shaped to maximize the interfacial surface area of the non-bonded interface 28 so long as the integrity and/or the functionality of the structural wall 12 is not compromised. The insert 22, in many instances, is intended to emulate the contour of the structural wall 12 and have a thickness—as measured in a direction consistent with a thickness measurement of the structural wall 12 from the inner surface 14 to the outer surface 16—that preferably ranges from about 10% to about 70%, and more preferably from about 30% to about 50%, of the thickness of the structural wall 12. The other two dimensions of the insert 22 are less crucial to the structural and functional integrity of the structural wall 12 and, as such, are generally chosen to accommodate the geometric profile of the selected damping region 20.

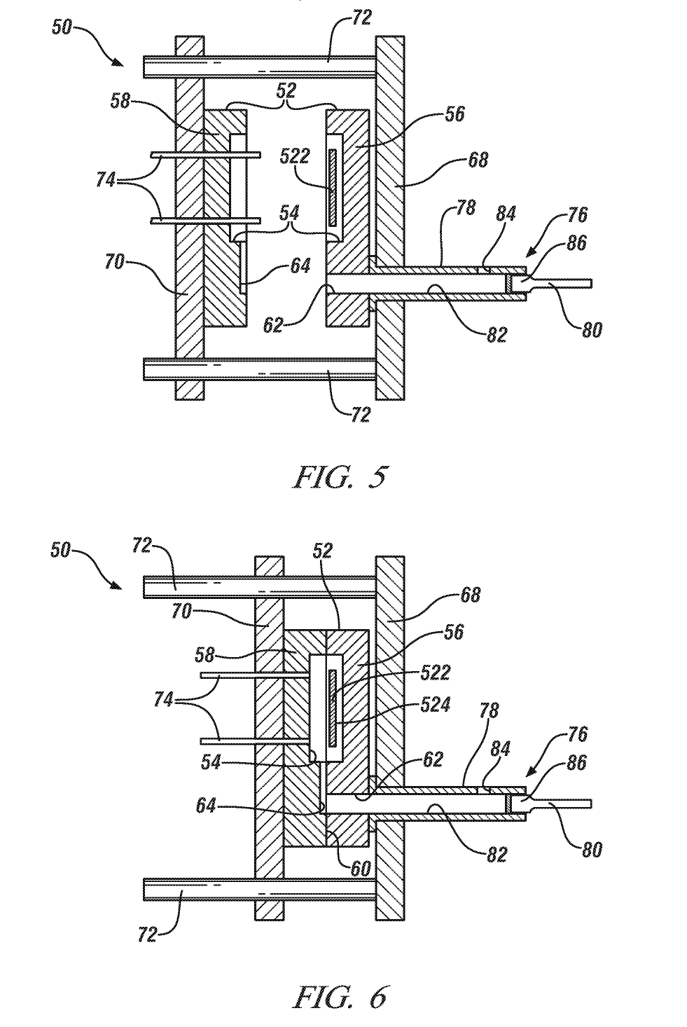

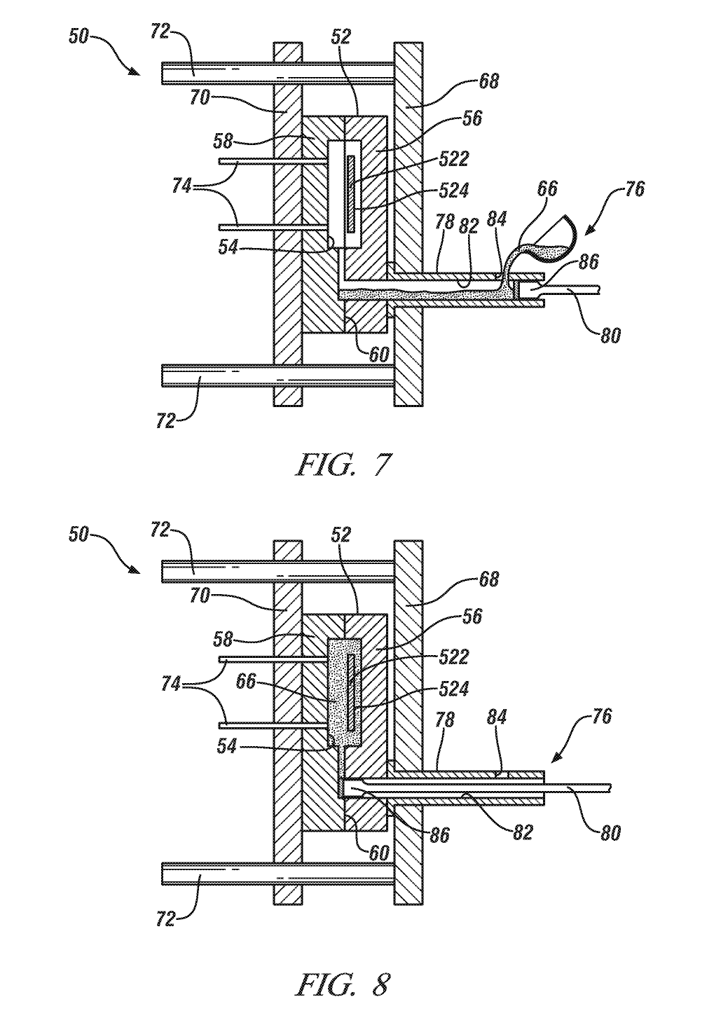

Several other embodiments of the vibration-damped precision cast aluminum alloy automotive member for a vehicle powertrain are shown in FIGS. 3 and 4. FIG. 3 generally depicts a vibration-damped electric motor housing 310 and FIG. 4 generally depicts a vibration-damped differential housing 410, each of which is precision cast from an aluminum alloy in similar fashion to the previously-described vibration-damped transmission housing 10. Both the vibration-damped electric motor housing 310 and the vibration-damped differential housing 410 include an internally disposed aluminum or aluminum alloy insert 322, 422 that forms a non-bonded interface with an interior surface of their respective housings 310, 410 at a selected damping region 320, 420. The external surface of the insert 322, 422 disposed within each of the electric motor housing 310 and the differential housing 410, like before, includes an exposed oxide film that facilitates formation of the non-bonded interface. In fact, the only real differences between the vibration-damped electric motor housing 310, the vibration-damped differential housing 410, and the vibration-damped transmission housing 10 (described in detail above) is the size, shape, and geometry of those precision cast automotive powertrain members and the components they are intended to enclose. Beyond that, the earlier description of the aluminum or aluminum alloy insert 22 and how it functions within the vibration-damped transmission housing 10 is entirely applicable the vibration-damped electric motor housing 310 and the vibration-damped differential housing 410 shown in FIGS. 3 and 4.

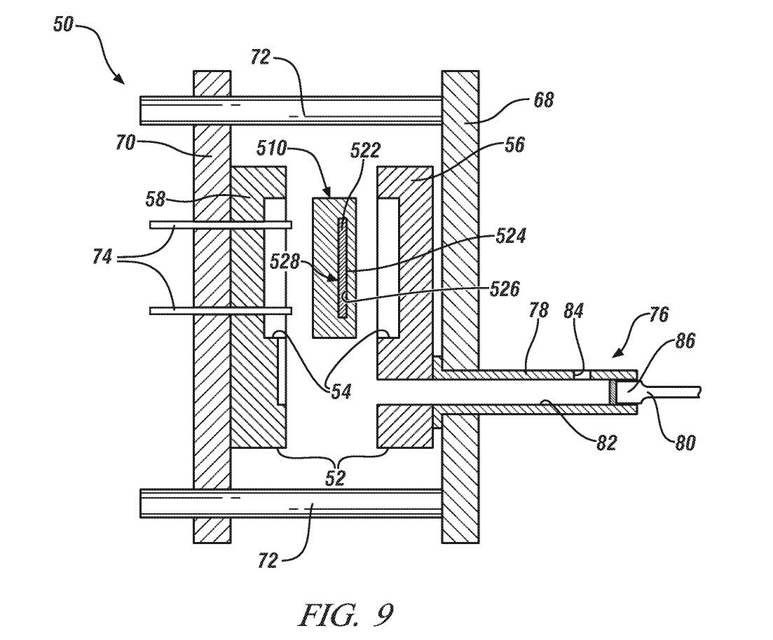

The vibration-damped aluminum alloy automotive powertrain members shown in FIGS. 1-4, as well as other similar automotive powertrain members, are preferably precision cast by a cold chamber die casting process. Cold chamber die casting, like many other forms of precision casting, utilizes a re-useable die and is able to fabricate a wide variety of aluminum alloy structures with a high degree of accuracy and repeatability from a molten aluminum alloy charge. Very tight dimensional tolerances can be achieved during cold chamber die casting and, in many instances, little or no additional machining is subsequently required. A schematic illustration of a typical cold chamber die casting process is shown in FIGS. 5-9. These Figures depict the cold chamber precision die casting of a generalized vibration-damped automotive powertrain member 510 that is meant to encompass, but is not limited to, each of the automotive powertrain members illustrated in FIGS. 1-4. The use of like numerals designates like features and indicates the applicability of earlier disclosures relevant to those particular features. Skilled artisans will undoubtedly know and appreciate the many variations and design modifications that can be employed to customize the cold chamber die casting process despite the fact that many of those nuances are not expressly shown and described here.

A cold chamber die casting apparatus 50, as shown in FIGS. 5-9, includes a re-useable die 52 which provides a die cavity 54 appropriately configured to form the particular automotive powertrain member being cast. A cover die half 56 and an ejector die half 58 that meet along a die parting line 60 under a hydraulic clamping force jointly define the die cavity 54. Retractable slides, cores, or other sections may be incorporated into the cover die half 56 and/or the ejector die half 58, although not specifically shown, to produce holes, hollow chambers, cavities, threads, or other desired shapes in the automotive powertrain member being cast. A shot hole 62 defined in the cover die half 56 and a runner 64 defined in the ejector die half 58 provide access to the die cavity 54 from outside the re-useable die for introducing a molten aluminum alloy charge 66. Internal cooling channels (not shown), moreover, may be present in one or both of the cover and ejector die halves 56, 58 to circulate a cooling fluid, such as water or oil, through the re-useable die 52. Each of the cover die half 56 and the ejector die half 58 is preferably constructed of a hardened tool steel alloy.

The cover die half 56 and the ejector die half 58 are preferably supported on a fixed platen 68 and a moveable platen 70, respectively, to facilitate opening and closing of the re-useable die 52. These platens 68, 70 are associated with alignment guides 72. The fixed platen 68 typically remains fixed relative to the alignment guides 72 while the moveable platen 70 is slidably received on the alignment guides 70 to accommodate aligned movement of the ejector die half 58 towards and away from the cover die half 56. A series of stationary ejector pins 74 mounted on an ejector base plate (not shown) are received through the moveable platen 70 and the ejector die half 58. The ejector pins 74 are flush with the die cavity 54 when the re-useable die 52 is closed along the die parting line 60 and extend through the ejector die half 58 when the re-useable die 52 is open and the ejector die half 58 is retracted from the cover die half 56. The opening of the re-useable die 52, as such, causes the ejector pins 74 to traverse the ejector die half 58 and eject the die cast automotive powertrain component so that it can be easily removed.

The cold chamber die casting apparatus 50 also includes a molten aluminum alloy high pressure injection mechanism 76 that injects the molten aluminum alloy charge 66 into the die cavity 54 at a high pressure. The molten aluminum alloy high pressure injection mechanism 76 includes a shot sleeve 78 and a hydraulically-operated plunger 80. The shot sleeve 78 defines a chamber 82 that fluidly communicates with the shot hole 62 of the cover die half 56. A pour hole 84 is defined in the shot sleeve 78 to permit the introduction of the molten aluminum alloy charge 66. The plunger 80 moves reciprocally within the shot sleeve 78 between an initial position and a forward position and includes a plunger head 86 that forms a dynamic seal with the chamber 82 during such movement. The plunger head 86 forces the aluminum alloy charge 66 through the shot hole 62 and into the die cavity 54 at which time the plunger head 86 maintains its forward position and applies a pressure on the charge 66 that usually ranges anywhere from about 1,500 psi to about 30,500 psi (10 MPa and 210 MPa).

Before cold chamber die casting of the vibration-damped aluminum alloy automotive powertrain member, however, the aluminum or aluminum alloy insert 522 with an exposed oxide film along its exterior surface 524 is obtained. The aluminum or aluminum alloy insert 522, for example, may be cut, stamped, or machined to the appropriate size and shape from sheet stock or, as an another option, it may be cast or otherwise fabricated from a molten aluminum or aluminum alloy source. A natural amorphous oxide layer ranging from about 1 nm to about 15 nm thick forms almost immediately on any bare surfaces of the aluminum or aluminum alloy insert 522 when exposed to oxygen by way of self-passivation. This oxide layer is thick enough to prevent the aluminum or aluminum alloy insert 522 from wetting during cold chamber casting of the aluminum alloy automotive powertrain member around the insert 522 and to ultimately facilitate formation of the non-bonded interface 528.

The exterior surface 524 of the aluminum or aluminum alloy insert 522 can also be provided with the oxide film up to about 20 μm by an anodizing process, if desired. Anodizing is an electrochemical process in which an oxide film is grown on an aluminum or aluminum alloy surface that is bare or already self-passivated with a natural oxide film. As part of the anodizing process, the aluminum or aluminum alloy insert 522 is immersed in a pH neutral or slightly acidic aqueous electrolyte solution and connected as the anode to a positive terminal of a direct-current (DC) power supply. The aqueous electrolyte solution is preferably maintained at room temperature of about 20° C. A rod or plate of an electrically conductive material that is inert to the electrolyte solution, such as carbon or nickel or stainless steel, is also immersed in the aqueous electrolyte solution and connected as the cathode to a negative terminal of the DC power supply to form an anodizing cell. When a closed-circuit exits in the anodizing cell, electrons are withdrawn from the aluminum or aluminum alloy insert 522 and delivered to the cathode. The loss of electrons at the anode generates aluminum ions which react with water in the aqueous electrolyte solution to form and grow the oxide film at the exterior surface 524 of the insert 522. The gain of electrons at the cathode generates hydrogen gas. Typical voltage and current density ranges encountered in the anodizing cell to form the oxide film are about 1 V to about 300 V and about 30 A/m² to about 300 A/m², respectively.

Certain physical and chemical properties of the oxide film—such as thickness, porosity, and solid state microstructure (amorphous/crystalline)—can be influenced by manipulating certain variables of the anodizing process. A pH neutral aqueous electrolyte solution generally produces a less porous barrier oxide film while a slightly acidic aqueous electrolyte solution generally produces a more porous oxide film. Electrolytes such as aluminum borate, aluminum phosphate, or aluminum tartrate can be used to make a pH neutral aqueous electrolyte solution. A slightly acidic aqueous electrolyte solution, on the other hand, is usually prepared with dilute (i.e., 1.0-2.0 M) sulfuric acid, phosphoric acid, chromic acid, or oxalic acid. Managing several process variables, moreover, including the electrolyte concentration, the temperature of the aqueous electrolyte solution, the voltage and current density of the anodizing cell, and the anodizing time, can predictably affect the thickness and hardness of the oxide film. Thicker oxide films tend to be produced in more dilute aqueous electrolyte solutions at lower temperatures in conjunction with higher voltages and current densities. Additionally, the solid state microstructure of the oxide film can be rendered crystalline by heating the self-passivated natural amorphous oxide film before anodizing and then anodizing the aluminum or aluminum alloy insert 522 at an elevated temperature. For example, in a preferred procedure, the aluminum or aluminum alloy insert 522 having a self-passivated natural amorphous oxide film can be heated to about 550° C. for thirty seconds to a few minutes and then anodized at about 70° C. to cultivate a crystalline oxide film at the exterior surface 524 of the insert 522.

Next, while the re-useable die 52 is open and the die cavity 54 is accessible, the aluminum or aluminum alloy insert 522 is located in the die cavity 54 at a predetermined site commensurate with the selected damping region 520 in the automotive powertrain member 510 being cast, as shown in FIG. 5. An emulsified lubricant is also typically applied to mold cavity 54 at this time. The insert 522 is located and held in position by retractable pins or some other positioning device as is generally understood by skilled artisans. After the aluminum or aluminum alloy insert 522 is properly located, movement of the moveable platen 70 towards the fixed platen 68 along the alignment guides 72 is initiated by conventional hydraulics (not shown). The moveable platen 70 moves towards the fixed platen 68 and brings the cover die and ejector die halves 56, 58 together along the die parting line 60, as shown in FIG. 6. A hydraulic clamping force ranging, for example, anywhere from 400 tons to 4,000 tons is typically established between the cover die and ejector die halves 56, 58 to securely delineate the die cavity 54. Locking pins and diametrically opposed receiving holes may also be present on the cover die and ejector die halves 56, 58 to help secure them together.

The molten aluminum alloy charge 66 is then poured into the shot sleeve 78 through the pour hole 84 by a manual or automated ladle in a prescribed quantity, as shown in FIG. 7. The molten aluminum alloy charge 66 is derived, for instance, by melting ingots in a separate furnace to temperatures of at least 590° C., and preferably above 650° C. so that alloy chemistry is maintained, and then delivering the molten aluminum alloy charge 66 to the ladle. Once the molten aluminum alloy charge 66 is present in the shot sleeve 78, the plunger 80 advances from its initial position at a relatively slow speed past the pour hole 84 and seals the chamber 80. The forward advancement of the plunger 80 then dramatically increases in speed to introduce the molten aluminum alloy charge 66 through the shot hole 62 and runner 64 and into the die cavity 54 where it contacts the exterior surface 524 of the aluminum or aluminum alloy insert 522. When the plunger 80 reaches its forward position and the die cavity 54 is filled with the molten aluminum alloy charge 66, as shown in FIG. 8, the hydraulic pressure that drives the plunger 80 is administered so that the pressure applied to the charge 66 in the die cavity 54 is preferably between about 1,500 psi to about 30,500 psi (10 MPa and 210 MPa) and most preferably between about 10,000 psi and 25,000 psi (69 MPa and 172 MPa).

The molten aluminum alloy charge 66 is allowed to cool and solidify in the die cavity 54 over and around the exterior surface 524 of the aluminum or aluminum alloy insert 522 to form the vibration-damped automotive powertrain member 510. The hydraulic clamping force applied between the fixed and moveable platens 68, 70 and the pressure applied to the molten aluminum alloy charge 66 by the plunger 80 are maintained during solidification while a cooling fluid is circulated through the re-useable die 52 to help extract heat. Solidification of the molten aluminum alloy charge 66 around the aluminum or aluminum alloy insert 522 does not initiate metallurgical bonding between the interior surface of the automotive powertrain member and the adjacent exterior surface 524 of the aluminum or aluminum alloy insert 522 due to the protective nature of the oxide film; rather, a non-bonded interface 528 is formed that provides the cast aluminum alloy automotive powertrain member 510 with its vibration-damping capability, as previously described.

Eventually, after a certain amount of time has passed, usually between one and five minutes, the hydraulic pressure administered by the plunger 80 and the hydraulic clamping force established between the fixed and moveable platens 68, 70 are relieved. The plunger 80 is then retracted to its initial position and the moveable platen 70 is moved away from the fixed platen 68 to separate the cover die and ejector die halves 56, 58, as shown in FIG. 9. The cast automotive powertrain member is temporarily retained in the ejector die half 58 during opening of the re-useable die 52. But the divergent movement of the ejector die half 58 causes the stationary ejector pins 74 to extend through the ejector die half 58 and delicately separate the cast automotive powertrain member 510 to permit removal. The ejected vibration-damped cast precision automotive powertrain member 510 is then further cooled and/or machined, if necessary, to realize its final form. Another cycle of the cold chamber casting process can now be repeated by applying more lubricant to the die cavity 54 and locating another aluminum or aluminum alloy insert 522 at the predetermined site.

The cold chamber die casting process just described is a preferred exemplary embodiment of a precision casting process that can be employed to manufacture the vibration-damped aluminum alloy automotive powertrain member 510. But other precision casting processes that utilize a re-useable die can also achieve the same outcome. A squeeze casting process, for example, involves locating the aluminum or aluminum alloy insert 522 in part of a die cavity defined by one die half, introducing the molten aluminum alloy charge 66 into the part of the die cavity, and then closing the re-useable die so that the other die half applies pressure to the aluminum alloy charge 66 after solidification has began. In another example, a gravity casting process (sometimes referred to as permanent mold casting), which is quite similar to cold chamber die casting, involves introducing the molten aluminum alloy charge into a die cavity under the force of gravity instead of the molten aluminum alloy high pressure injection mechanism 76.

The above description of exemplary embodiments is merely descriptive in nature and not intended to limit the scope of the claims that follow. Each of the terms used in the appended claims should be given its ordinary and customary meaning unless specifically and unambiguously stated otherwise in the specification.

1. A method of making a vibration-damped precision cast aluminum alloy automotive member for a vehicle powertrain, the method comprising:
obtaining an insert, which is constructed of aluminum or an aluminum alloy, that comprises an oxide film exposed at an exterior surface of the insert, the oxide film having a thickness that ranges from about 1 nm to about 20 μm; and
solidifying a molten aluminum alloy charge around the insert in a die cavity defined by a re-useable die and configured to resemble an automotive powertrain member, the insert being positioned in the die cavity at a predetermined site, and the molten aluminum alloy charge being solidified into a vibration-damped automotive powertrain member that includes a non-bonded interface between an interior surface of the automotive powertrain member and the oxide film at the exterior surface of the insert so that frictional contacting movement transpires between the interior surface and the oxide film when the automotive powertrain member is subjected to vibratory excitement;
wherein the vibration-damped automotive powertrain member comprises a structural wall that includes an inner surface and an outer surface, the structural wall having a thickness between the inner surface and the outer surface that ranges from about 2 mm to about 20 mm, and wherein the aluminum or aluminum alloy insert has a thickness, measured in a direction consistent with the thickness of the structural wall from the inner surface to the outer surface, that ranges from about 10% to about 70% of the thickness of the structural wall.

2. The method set forth in claim 1, wherein obtaining the insert comprises forming the oxide film at the exterior surface of the insert by exposing a bare aluminum or aluminum alloy surface of the insert to oxygen to promote self-passivation.

3. The method set forth in claim 1, wherein obtaining the insert comprises forming the oxide film at the exterior surface of the insert by anodizing either a bare or passivated aluminum or aluminum alloy surface of the insert.

4. (canceled)

5. The method set forth in claim 1, further comprising:
introducing the molten aluminum alloy charge into the die cavity and into contact with the exterior surface of the insert under an applied elevated pressure.

6. The method set forth in claim 5, wherein the elevated pressure applied to the molten aluminum alloy charge in the die cavity is in the range of about 1,500 psi to about 30,500 psi.

7. The method set forth in clam 1, wherein the die cavity is configured to resemble a transmission housing, an electric motor housing, a differential housing, or an invertor housing.

8. A method of making a vibration-damped precision cast aluminum alloy automotive member for a vehicle powertrain, the method comprising:
forming an oxide film at an exterior surface of an aluminum or an aluminum alloy insert by anodizing either a bare or passivated surface of the insert, the oxide film having a thickness that ranges from about 1 nm to about 20 μm;
locating the insert in a die cavity defined by a re-useable precision casting die, the die cavity being shaped to resemble an automotive member for a vehicle powertrain;
introducing a molten aluminum alloy charge into the die cavity and into contact with the exterior surface of the insert under an applied elevated pressure; and
solidifying the molten aluminum alloy charge over the exterior surface of the insert to form the vibration-damped automotive powertrain member having a non-bonded interface between an interior surface of the automotive powertain member and the oxide film at the exterior surface of the insert so that frictional contacting movement transpires between the interior surface and the oxide film when the automotive powertain member is subjected to vibratory excitement.

9-11. (canceled)

12. The method set forth in claim 8, wherein the elevated pressure applied to the molten aluminum alloy charge in the die cavity is in the range of about 1,500 psi to about 30,500 psi.

13. The method set forth in claim 8, wherein the automotive powertrain member is a housing that includes a structural wall having an inner surface and an outer surface, the structural wall having a thickness between the inner and outer surfaces from about 2 mm to about 20 mm, and wherein the aluminum or aluminum alloy insert is disposed within the structural wall.

14. The method set forth in claim 13, wherein the aluminum or aluminum alloy insert is disposed in the structural wall between the inner and outer surfaces, and wherein the aluminum or aluminum alloy insert has a thickness, measured in a direction consistent with the thickness of the structural wall from the inner surface to the outer surface, that is between about 10% and about 70% of the thickness of the structural wall.

15. A vibration-damped precision cast aluminum alloy automotive member for a vehicle powertrain comprising:
a precision cast aluminum alloy automotive member for a vehicle powertrain constructed of aluminum or an aluminum alloy that includes an interior surface; and
an insert disposed within the precision cast aluminum alloy automotive member, the insert being constructed of aluminum or an aluminum alloy and comprising an exterior surface that forms a non-bonded interface with the interior surface of the automotive member, the exterior surface of the aluminum insert having an oxide film exposed at the non-bonded interface of the exterior surface of the insert and the interior surface of the automotive member.

16. The vibration-damped precision cast aluminum alloy automotive member for a vehicle powertrain set forth in claim 15, wherein the oxide film has a thickness between about 1 nm and about 20 μm.

17. The vibration-damped precision cast aluminum alloy automotive member for a vehicle powertrain set forth in claim 15, wherein the automotive powertrain member is a housing that includes a structural wall having an inner surface and an outer surface, the structural wall having a thickness between the inner and outer surfaces from about 2 mm to about 20 mm, and wherein the aluminum or aluminum alloy insert is disposed within the structural wall.

18. The vibration-damped precision cast aluminum alloy automotive member for a vehicle powertrain set forth in claim 17, wherein the automotive member for a vehicle powertrain is a transmission housing, an electric motor housing, a differential housing, or an invertor housing.

19. The vibration-damped precision cast aluminum alloy automotive member for a vehicle powertrain set forth in claim 17, wherein the aluminum or aluminum alloy insert is disposed in the structural wall between the inner and outer surfaces, and wherein the aluminum or aluminum alloy insert has a thickness, measured in a direction consistent with the thickness of the structural wall from the inner surface to the outer surface, that is between about 10% to about 70% of the thickness of the structural wall.

20. The vibration-damped precision cast aluminum alloy automotive member for a vehicle powertrain set forth in claim 15, wherein the aluminum or aluminum alloy insert is not covered with a coating that comprises refractory particles.

21. The method set forth in claim 1, wherein the aluminum or aluminum alloy insert is not covered with a coating that comprises refractory particles.

22. The method set forth in claim 8, wherein the aluminum or aluminum alloy insert is not covered with a coating that comprises refractory particles.

23. The method set forth in claim 8, wherein the anodizing comprises:
providing an aqueous electrolyte solution;
immersing the aluminum or aluminum alloy insert into the aqueous electrolyte solution and connecting the aluminum or aluminum alloy insert to a power supply as an anode; and
immersing an electrically conductive material, which is inert to the aqueous electrolyte solution, into the aqueous electrolyte solution and connecting the electrically conductive material to the power supply as a cathode.

24. The method set forth in claim 8, wherein the anodizing is performed so that the oxide film has a crystalline microstructure.
